(19) United States
(12) Patent Application Publication
(10) Pub. No.: US 2003/0199290 A1
(43) Pub. Date: Oct. 23, 2003

(54) Portable, foldable electronic device equipped with telephone functions and camera functions

(75) Inventor: Kimmo Viertola, Vesilahti (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/417,498

(22) Filed: Apr. 17, 2003

(30) Foreign Application Priority Data
Apr. 17, 2002 (FI) 20020737

(51) Int. Cl. H04B 1/38

(52) U.S. Cl. 455/575.1; 455/575.3; 455/90.3

(57) ABSTRACT

Portable, foldable electronic device equipped with telephone functions and camera functions, and comprising at least a first housing part a second housing part, hinge means, which are arranged to fold the housing parts into different operating positions, a closed operating position in which the rear walls of the housing parts are positioned against each other, an opened operating position in which the front walls of the housing parts are positioned next to each other, and camera means integrated in said device. The device also comprises keyboard means placed on the front wall of the first housing part and display means for presenting information, which are placed on the front wall of the second housing part and arranged for presenting information both in the opened and closed position. The camera means are either directed or can be directed substantially to the opposite direction in relation to the display means when the device is in the closed operating position and substantially in the same direction in relation to the display means when the device is in the open operating position. In an embodiment, the main orientation of the information that is presented in the display means and can be read or viewed is also arranged to be changed at least in such a manner that the main orientation of the closed operating position would deviate from the main orientation of the open operating position.

### TECHNICAL FIELD

The invention relates to a portable, foldable electronic device that is equipped with telephone functions and camera functions. The invention also relates to a method in a portable, foldable electronic device that is equipped with telephone functions and camera functions.

### BACKGROUND ART

According to prior art, mobile station functions and camera functions have been connected to electronic devices. The telephone is especially a portable cellular network phone and the camera functions may include the act of taking single images for transmission as well as the reception of the same, as well as transmission and reception of the live video image for video calls. The device typically contains the necessary memory means for storing digital images.

One known portable device is disclosed in the U.S. Pat. No. 6,069,648. Said device comprises two housing parts, on the inner sides of which display means and keyboard means have been arranged. The housing parts are connected by means of a hinge, in which a camera that can be directed is integrated. The inner walls of the device (i.e. front walls) are positioned against each other in the closed position wherein the device and the displays cannot be used.

Devices of prior art are not, however, convenient in use because the use of the camera in the open position of the device is difficult, and the user must also constantly make sure that the camera is directed accurately. In devices of prior art, the camera must be manually directed away from the user when pictures are taken, and for example for a video call it must be directed towards the user. Thus, act of changing the operating mode of the device may take place slowly.

The use of devices in different operating modes is typically controlled by means of menus presented on the display, the device operating by means of the menus for example in the telephone mode or camera mode. For this reason precisely, the implementation of the devices may be slow, because the devices must be opened in the correct position, it must be switched on, the mode of the device must be checked and selections must be made to change the operating mode.

### DISCLOSURE OF THE INVENTION

It is an aim of the present invention to introduce a foldable electronic device that is easy to use and to eliminate the above-mentioned problems. One purpose of the new device is to facilitate and accelerate the implementation of the device and to make the act of changing the basic mode more convenient. A special aim is that the device is small in size and easy to handle when the camera functions are in use.

A special aim is to utilize a predetermined same display in different situations both in connection with camera functions and telephone functions and in connection with other functions as well, if necessary. It is an advantage that it is not necessary to use separate displays. One display can now be used both in the closed and open position which is made possible by means of the correct placement of the display and the other members of the device as well as by changing the orientation of information.

One purpose of a preferred embodiment of the invention is especially to direct the camera closely to the appropriate direction for each situation of use. The different operating positions of the device are intuitive and clear to use wherein it is easy to detect the operating mode in use merely on the basis of the position of the device. Thus, the camera functions and the operating position and shape of the device resemble a conventional camera, and the telephone functions and the operating position of the device resemble a conventional foldable mobile phone.

It is a purpose of a preferred embodiment of the invention to further facilitate the use of the device in such a manner that the position and orientation of the information presented on the display can be changed for different operating positions. Thus, the advantage is that it is easier to turn the device from one operating position to another, and it is not tied to the fixed orientation of the display. In an embodiment of the invention the use is further facilitated in such a manner that the change is automatically conducted, wherein the user only has to take care of changing the operating position of the device.

The act of changing the orientation makes it possible to use new operating positions. Primarily, the act of changing the orientation makes is possible that the camera may be directed to a fixed direction, but despite of that the aforementioned new operating positions as well as the easy use of the device are possible according to the requirements of different situations.

One central principle of the invention is that the keyboard and display are placed on the outer walls (i.e. front walls), although the device can be folded in such a manner that the inner walls (i.e. rear walls) are positioned against each other, wherein the device is as small and slim as possible and is well suited for camera use. In the telephone use the outer walls face the user, giving an expression similar to an opened foldable telephone in which the keyboard and the display are typically placed on top of each other.

The automatic nature accelerates and facilitates the use of the device, wherein the different positions of the device are used for indicating the desired operating mode. One important factor is the act of directing the camera means readily in the accurate direction, as well as placing the same in such a manner that they are suitable both for camera and telephone use.

### BRIEF DESCRIPTION OF THE DRAWINGS

In the following, the invention will be described in more detail by using as examples some advantageous embodiments with reference to the appended drawings, in which

FIG. 1 shows the electronic device according to an embodiment of the invention in a closed operating position, seen from the side of the outer wall,

FIG. 2 shows the electronic device according to FIG. 1, in a closed operating position, seen from the side of the opposite outer wall,

FIG. 3 shows the electronic device according to FIG. 1, in an opened operating position, seen from the side of both outer walls, and

FIG. 4 shows the electronic device according to FIG. 1, in an opened operating position, seen from the side of both inner walls.

### MODES FOR CARRYING OUT THE INVENTION

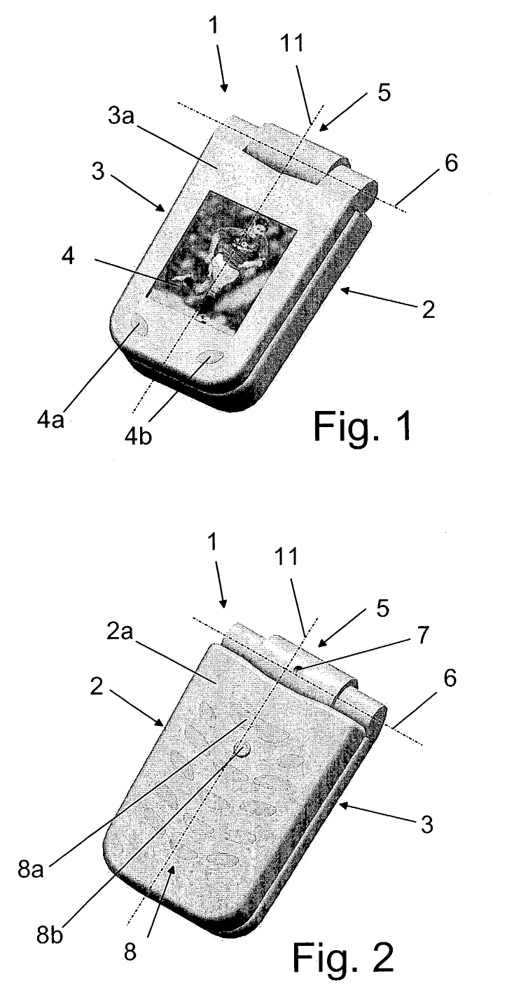

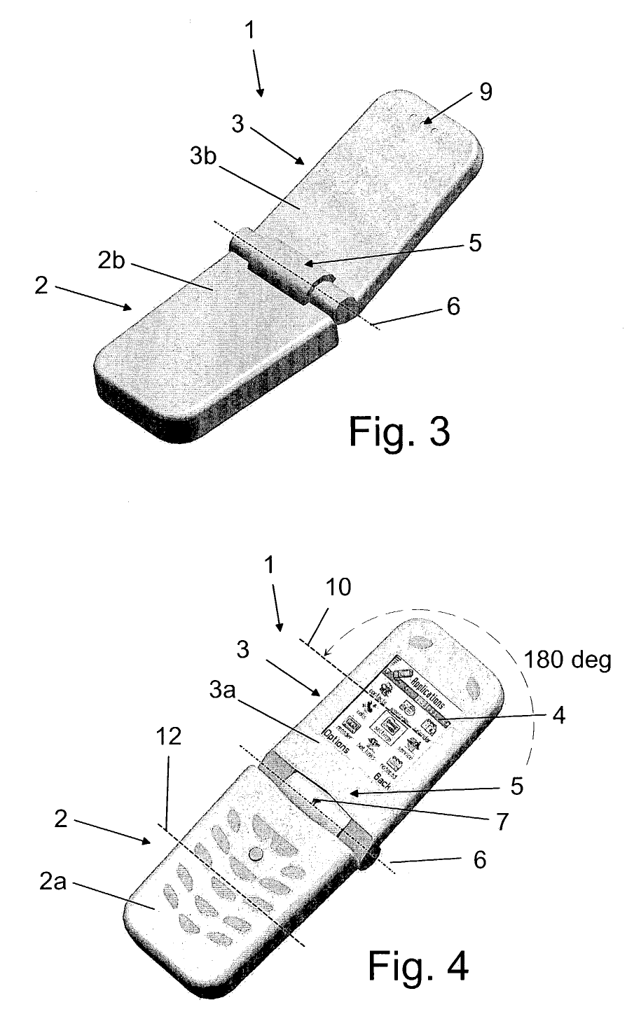

With reference to FIGS. 1 to 4, the electronic device 1 comprises a first housing part 2 with a front wall 2a and a rear wall 2b, and a second housing part 3, with a front wall 3a and a rear wall 3b as well. The device 1 also comprises hinge means 5 that are positioned between the housing parts 2, 3 to attach them together and to fold them in such a manner that in the closed position according to FIGS. 1, 2, the rear walls 2b, 3b of the housing parts 2, 3 are placed against each other, being preferably supported against each other. Correspondingly, in the opened position of FIGS. 3, 4, the front walls 2a, 3a of the housing parts 2, 3 are substantially directed to the same direction, wherein the housing parts 2, 3 are at the same time positioned for example next to each other. FIGS. 1 and 2 show a closed operating position of the device 1, in which position the device 1 is in the camera mode, wherein the display means 4 of the outer wall 3a of the first housing part 3 can be used for presenting a single image taken by the camera means 7, or an image produced in real time by the camera means 7, wherein the display 4 functions as a view finder of the camera to facilitate the directing of the camera 7.

In the closed operating position the camera is substantially directed to the opposite direction in relation to the display 4, and substantially to the same direction with the keyboard 8. In the open operating position the camera 7 is directed substantially to the same direction in relation to the display 4 and the keyboard 8. On the front wall, in connection with the display 4, there are typically one or more keys, buttons or other manual control means 4a, 4b, by means of which it is possible to control the function of the display 4 or make selections by means of the menus presented on the display 4. The keys 4a, 4b can also be used for controlling other functions of the device 1.

For the different embodiments of the device 1, the camera 7 and the orientation of the same are arranged to the desired direction either in view of camera functions or telephone functions. Preferably, the camera 7 is, however, directed so that both these alternatives are possible.

The keyboard means 8 of the device 1 are placed on the front wall 2a of the second housing part 2. It is also possible to use a touch screen as the keyboard means 8. If necessary, the keyboard means 8 can be at least partly protected with a separate cover to prevent erroneous pressings. In the closed operating position the device 1 is small and convenient to use, because the housing parts 2, 3 can be kept in a position where they are placed against each other. The display 4 is directed towards the user, and the camera 7 away from the user, when the device 1 is held on a palm. The keyboard 8 typically comprises the operating keys typical for a mobile phone, and in addition to them other manual control means 8a that are used for controlling the menus presented on the display, or control means 8b that can also be used for releasing the shutter of the camera or for other kind of control. The device can also include other keys, which are positioned for example in the edge portions of the housing parts, for example an on/off button, or the adjuster of the volume of the speaker 9.

The main orientation of the keyboard 8 and the main orientation of the information on the display are selected so that they are similar and so that if the device 1 is turned in the hand around a longitudinal rotation axis 11, both the keyboard 8 and the information on the display 4 are preferably the right way up, and for example the information on the display 4 is not upside-down after the turning. Thus, the camera 7 can be fixedly directed to the same direction with the keyboard, and thus it is not necessary for the user to direct the camera 7 separately. Another requirement is that in the closed position of the device 1, the display 4 and the keyboard 8 are positioned on the outer walls, in other words on the front walls 2a, 3a.

The concept of main orientation refers to the orientation of the information or keyboard that is set as default or that is mainly utilized in the normal operating position or in the operating position in which the device is normally intended to be used. In the normal operating positions of the device according to FIGS. 1 to 4, the hinge means 5 are located at the upper edge (FIGS. 1 and 2) of the device or the display 4 is located above the keyboard 8 (FIGS. 3 and 4). When the telephone functions are used, the main orientation 10 of the display 4 follows for example the main orientation 12 of the keyboard 8, and thus it is not necessary to turn the device 1 in the hand so that it would be easy to use the display 4 and on the other hand the keyboard 8. The change of orientation can be conducted under the control of the user and according to selections, for example by pressing keys, but this applies mainly to special situations and to positions other than the primary operating position and main orientation intended by the manufacturer of the device.

The upper edge is a good alternative for the placement of the camera, because then the hand holding the device 1 is not easily positioned in front of the camera 7. The camera means 7 are integrated in the device 1. The camera 7 is preferably integrated in the hinge 5 and in such parts of the hinge 5 that are not rotated or do not move in relation to the housing part 3, wherein the camera 7 can also be fixedly directed to the correct direction. The correct direction depends on the purpose of use of the display 4. The camera 7 can also be positioned for example in the upper part of the keyboard 8, but the structure of the hinge 5 is now according to FIG. 2 such that the housing part 3 does not turn in relation to the camera 7, when the device is in the open or closed operating position. The hinge comprises two projections that extend from the side wall of the housing part 3, and between which there is a projection extending from the side wall of the housing part 2. The camera 7 is preferably positioned in the projection of the housing part 2.

In the open operating position the device 1 functions as a telephone, wherein the display 4 and the keyboard 8 face the user. The housing parts 2, 3 are positioned next to each other, preferably in parallel. By means of the hinge 5 it is possible to restrict the angle between the housing parts 2, 3 into a suitable size, or even allow the positioning of the front walls against each other into a transport position, wherein the display 4 and the keyboard 8 are protected, and unintentional pressings are prevented at the same time. By means of the hinge 5 it is possible to arrange desired intermediate positions for the housing parts 2, 3, wherein the device 1 can be placed for example on a table so that the display 4 is slightly folded towards the user. At the same time it is advantageous that the camera 7 can also be moved and thus directed towards the user. The device 1 can, of course, be equipped with foldable supporting feet or means, located on the rear wall 2b, wherein the fixed camera 7 is better directed towards the user.

The orientation of the information refers for example to the position of the text in the most common operating position, especially when the readability and the act of viewing an image are considered. A change in the orientation can for example result in that the text or image information already positioned on the display 4 is turned 180 degrees (180°), or for example in that when the search for a new text or a new image begins, the orientation of the same is selected according to the position of the device 1. The position of the device 1 must be determined for example when the device is switched on so that the instructions and menus can be immediately presented in the position required by the operating position of the device 1.

In the telephone mode according to FIGS. 2 and 3, the orientation 12 of the keyboard 8 and the main orientation 10 of the information on the display 4 are in the normal operating position selected to be similar, and such that the information on the keyboard 8 and on the display 4 are both preferably the right way up, and for example the information on the display 4 is not upside-down after the opening. The control means controlling the display 4 are arranged in such a manner that the opening of the display into the position according to FIG. 4 results in that the main orientation 10 of the information presented on the display is turned 180 degrees (180°) when compared to the operating situation shown in FIG. 1. Thus, the fixed camera 7 is directed to the same direction with the keyboard 8, i.e. towards the user, and thus it is not necessary for the user to direct the camera 7 separately. The camera 7 is now directed towards the user, being thereby ready for video calls.

The advantage attained by arranging the act of changing the main orientation 10 of the display 4 in the presented manner, and by placing the display 4 and the keyboard 8 in the presented manner is that the camera 7 can be directed to a fixed direction. The camera 7 can, of course, be movable and it may be possible to direct it according to prior art, wherein the camera 7 is turned especially around a rotating axis 6, which is parallel to the rotating axis of the hinge 5, or even convergent with the same. The movability, however, makes the structure more complex and sensitive to failure, and it is possibly directed to the wrong direction when the user wishes to rapidly take the device in use.

The operating position of the device 1 is preferably determined with sensor means positioned in the hinge 5, which sensor means indicate the position to the control system of the device 1, which also takes care of controlling the display 4 and at the same time the orientation of the information contained therein. More detailed structure of the hinge 5, the sensor means, more detailed structure of the display 4 and the keyboard 8 and the function of the same, as well as the control system of the device 1 can comply with prior art, and therefore they will not be described in more detail in this context. The act of modifying the control of the display 4 and the control system for the above-described function is obvious for anyone skilled in the art on the basis of the information provided in this description. It is possible to place sensor means in a suitable location in the housing part of the device 1, said sensor means detecting for example if the second housing part is located in the vicinity, wherein it is possible to determine the position of the device and control the orientation by means of said sensor. Furthermore, by means of the same or different sensor means it is possible to detect when the device has been placed on the ear of the user or in the vicinity of the same, wherein the display can be switched off, because the user cannot see the display 4, or to save power.

The main orientations 10 of the closed and open operating position change 90 degrees (90°) in such a case where the housing parts 2 and 3 are intended to be located next to each other in the open position, but in the camera mode the operating position complies, however, with the position shown in FIG. 1. Thus, the keyboard 8 has rotated 90 degrees either clockwise or counterclockwise.

In an embodiment the front walls 2a, 3a of the device 1 are positioned against each other, but the positioning of the rear walls 2b, 3b against each other is not necessary. Thus, the hinge 5 is positioned horizontally in the middle of the device 1 when said device is open. The main orientation of the keyboard 8 and the display 4 corresponds to the rotation axis 6 of the hinge 5, when the device 1 is open. It is not necessary to change to orientation. The camera is now positioned next to the display 4 on the front wall 3a and directed towards the user, and to the same direction with the display 4. In the housing part 2, an opening, a notch or another shaping has been arranged at the location of the camera 7, so that the housing part 2 would not cover the camera 7 when the front walls 2a, 3a, are located against each other. On the other hand, the housing part 2 may be shorter in length than the housing part 3, wherein it does not extend on top of the camera 7. Furthermore, a view finder is also placed on the rear wall 3b, said view finder being for example optical and extending through the housing part 3, wherein the housing part 2 must not be located in front of the view finder either. When the camera functions are used, the device 1 is very compact and resembles a camera. The shutter release of the camera can be placed on top of the housing part 3, for example in such a location that corresponds to the location of the shutter release in a conventional camera.

The invention is not limited solely to the above-presented few embodiments, but it can be modified in accordance with the appended claims.

1. A portable, foldable electronic device, equipped with telephone functions and camera functions, and comprising at least:
a first housing part comprising a front wall and a rear wall,
a second housing part also comprising a front wall and a rear wall,
hinge means that are arranged for attaching said housing parts to each other, and folding the same into different operating positions,
a closed operating position, in which the rear walls are positioned against each other, and the front are directed to substantially opposite directions,
an opened operating position, in which the front walls are positioned next to each other, and directed substantially to the same direction,
camera means,
keyboard means placed on the front wall of the first housing part, and
display means for presenting information, which are placed on the front wall of the second housing part and arranged for presenting information both in the opened and closed position.

2. The foldable electronic device according to claim 1, wherein the camera means are either directed or can be directed substantially to the opposite direction in relation to the display means when the device is in the closed operating position and substantially to the same direction in relation to the display means when the device is in the open operating position.

3. The foldable electronic device according to claim 1, wherein the camera means are directed in a fixed manner.

4. The foldable electronic device according to claim 1, wherein the main orientation of the information that is presented in the display means and can be read or viewed is also arranged to be changed at least in such a manner that the main orientation of the closed operating position would deviate from the main orientation of the open operating position when the display means are directed towards the user in the closed operating position, and when both the keyboard means and the display means are directed towards the user in the open operating position.

5. The foldable electronic device according to claim 4, wherein the device is arranged to change the main orientation of the display means automatically when the device is transferred from the open operating position to the closed operating position or back.

6. The foldable electronic device according to claim 4, wherein in the open operating position the main orientation of the display means corresponds to the main orientation of the keyboard means.

7. The foldable electronic device according to claim 4, wherein in the closed operating position the main orientation of the display means corresponds to the main orientation of the keyboard means in such a manner that the device can be turned into different operating positions around a vertical rotating axis.

8. The foldable electronic device according to claim 4, wherein in the closed operating position the hinge means are positioned on the upper edge of the device.

9. The foldable electronic device according to claim 4, wherein the main orientation of the open operating position of the display means deviates 180° from the main orientation of the closed operating position.

10. The foldable electronic device according to claim 4, wherein in the closed operating position the hinge means are positioned on the left or right side wall of the device.

11. The foldable electronic device according to claim 4, wherein in the main orientation of the open operating position of the display means deviates 90° from the main orientation of the closed operating position.

12. The foldable electronic device according to claim 1, the camera means are directed to a substantially opposite direction in relation to said display means in a fixed manner.

13. The foldable electronic device according to claim 1, wherein for the directing purpose the above-mentioned camera means can be rotated around such rotating axis which is parallel to the rotating axis of the hinge means.

14. The foldable electronic device according to claim 1, wherein the camera means are integrated in the hinge means.

15. The foldable electronic device according to claim 1, wherein in the closed operating position the camera means are positioned on the upper edge of the device.

16. The foldable electronic device according to claim 1, wherein the keyboard means comprise at least a keyboard, which is intended for controlling the functions of a mobile phone and camera means.

17. The foldable electronic device according to claim 1, wherein when the camera means are used and in the closed operating position the device is arranged to be held on a palm in such a manner that the display means are directed towards the user and the camera means are directed away from the user, and the display means are arranged to present a continuous image or a single image taken by the camera means, or both of these.

18. The foldable electronic device according to claim 1, wherein when the camera means are used and in the open operating position the device is arranged to be held on a palm in such a manner that the display means and the camera means are directed towards the user.

19. The foldable electronic device according to claim 1, wherein the hinge means also comprise sensor means that are arranged to determine whether the device is in a closed or open operating position and to give an indication relating to the position to said device.

20. The foldable electronic device according to claim 2, wherein the main orientation of the information that is presented in the display means and can be read or viewed is also arranged to be changed at least in such a manner that the main orientation of the closed operating position would deviate from the main orientation of the open operating position when the display means are directed towards the user in the closed operating position, and when both the keyboard means and the display means are directed towards the user in the open operating position.

21. The foldable electronic device according to claim 20, wherein in the closed operating position the main orientation of the display means corresponds to the main orientation of the keyboard means in such a manner that the device can be turned into different operating positions around a vertical rotating axis.

22. The foldable electronic device according to claim 20, wherein the main orientation of the open operating position of the display means deviates 180° or 90° from the main orientation of the closed operating position.

23. The foldable electronic device according to claim 17, wherein when the camera means are used and in the open operating position the device is arranged to be held on a palm in such a manner that the display means and the camera means are directed towards the user.

24. The foldable electronic device according to claim 20, wherein when the camera means are used and in the closed operating position the device is arranged to be held on a palm in such a manner that the display means are directed towards the user and the camera means are directed away from the user, and the display means are arranged to present a continuous image or a single image taken by the camera means, or both of these.

25. The foldable electronic device according to claim 24, wherein when the camera means are used and in the open operating position the device is arranged to be held on a palm in such a manner that the display means and the camera means are directed towards the user.

26. The foldable electronic device according to claim 20, wherein the hinge means also comprise sensor means that are arranged to determine whether the device is in a closed or open operating position and to give an indication relating to the position to said device.

27. A method in a portable, foldable electronic device, equipped with telephone functions and camera functions, and comprising at least:
a first housing part comprising a front wall and a rear wall,
a second housing part also comprising a front wall and a rear wall,
hinge means that are arranged for attaching said housing parts to each other, and folding the same into different operating positions,
a closed operating position, in which the rear walls are positioned against each other, and the front walls are directed to substantially opposite directions,
an opened operating position, in which the front walls are positioned next to each other, and are directed substantially to the same direction,
camera means,
keyboard means placed on the front wall of the first housing part, and
display means for presenting information, which are placed on the front wall of the second housing part and arranged for presenting information both in the opened and closed position,
wherein the method comprises the step of:
changing the main orientation of the information that is presented in the display means and can be read or viewed, in such a manner that the main orientation of the closed operating position deviates from the main orientation of the open operating position when the display means are intended to be directed towards the user in the closed operating position, and when both the keyboard means and the display means are intended to be directed towards the user in the open operating position.

28. The method according to claim 27, wherein the hinge means also comprise sensor means, wherein utilizing the sensor means to determine whether the device is in the closed or open operating position and to give an indication relating to the position to said device to change the main orientation.

29. The method according to claim 27, further comprising the step of selecting the main orientation of the open operating position to deviate 180° or 90° from the main orientation of the closed operating position.

30. The method according to claim 28, further comprising the step of selecting the main orientation of the open operating position to deviate 180° or 90° from the main orientation of the closed operating position.
